(19) United States
(12) Patent Application Publication
(10) Pub. No.: US 2010/0094707 A1
(43) Pub. Date: Apr. 15, 2010

(54) METHOD AND PLATFORM FOR VOICE AND LOCATION-BASED SERVICES FOR MOBILE ADVERTISING

(76) Inventor: Carl Johan FREER, Westport, CT (US)

Correspondence Address: FRISHAUF, HOLTZ, GOODMAN & CHICK, PC, 220 Fifth Avenue, 16TH Floor, NEW YORK, NY, 10001-7708, US

(21) Appl. No.: 12/578,516

(22) Filed: Oct. 13, 2009

Related U.S. Application Data
(60) Provisional application No. 61/104,530, filed on Oct. 10, 2008.

(51) Int. Cl. G06Q 30/00; G10L 15/00; H04W 4/02

(52) U.S. Cl. 705/14.54; 704/231; 705/14.58; 455/456.3; 704/E15.001

(57) ABSTRACT

A platform is provided which enables advertisers to send targeted advertisements to a user of a mobile device based on the user's vocal commands at the mobile device and the location of the mobile device. The platform allows advertisers to specify keywords, locations and content that is to be delivered to the users, The platform also includes an application that resides on the mobile device that leverages components which help in determining the location of the mobile device as well as capture audio information. Upon capturing the user's voice query, it is sent to a server, where it is decoded into its text equivalent and returned. The resultant text is then combined with the location of the user and forwarded to an advertising server which directs delivery of multimedia components to a receiving device.

### CROSS-REFERENCE TO RELATED APPLICATION

This application claims priority under 35 U.S.C. §119(e) of U.S. Provisional Patent Application Ser. No. 61/104,530 filed Oct. 10, 2008, which is incorporated by reference herein.

### FIELD OF THE INVENTION

The present invention relates generally to methods and techniques that leverage location information in combination with voice-recognition to provide contextual advertisements for users of mobile devices.

The present invention also relates to a platform designed to support these services.

### BACKGROUND OF THE INVENTION

It is well-known that the computational capability found in mobile devices is increasing at exponential rates, even as the size of the mobile devices decrease. As a result, manufacturers of mobile devices are now able to include components that were not previously possible. For example, mobile phones from about five years ago were limited to hardware capable of performing only a few primary features such as basic calling and contact information services. Today, mobile phones include hardware that can run full-blown multimedia applications, and can store vast amounts of information. Furthermore, today's mobile devices contain advanced hardware that enhances the user experience, such as a camera and a UPS (Global Positioning System) unit that includes location, accelerometers and orientation sensors.

One of the primary advantages of mobile computing is its portability. Users can carry mobile devices anywhere that they want to go, and most often, these devices are always within close proximity to their users. Thus, the environment that surrounds the user often changes and ideally, many applications could benefit from understanding the context of the user. As used herein, the “context” of the user will generally mean the user's geographic location and surrounding environment. For example, if a mobile device is aware that its user is in a meeting, it may adjust its ringtone to vibrate mode, or may disable incoming calls. Similarly, if the mobile device determines that the user is moving towards a general location or is within the proximity of a general location, this may serve as a valuable piece of information to establish context.

GPS-enabled mobile devices are somewhat limited in precision and accuracy of the location determination, but are often sufficient enough for general purpose, location-based services. Perhaps the most common example is found in car navigation services offered by TomTom, Garmin and other vendors. The purpose of such systems is to provide location-related services for the user.

It is often difficult to enter text into many mobile devices. To overcome this difficulty, mobile services have recently begun to include voice-recognition technology to enable hands-free entry of text. The accuracy of such systems varies widely, but again is sufficient for certain mobile applications. Examples of this technology include Windows Live wherein a user can speak into their phone to construct a search within a Web browser; however, this search is not location specific.

While these technologies have existed independently for several years, no applications are currently known to exist that allow advertisers to promote their products or services using a combination of location and voice recognition. This powerful technique can provide new advertising avenues to create novel user impressions that are not possible through the use of location-based advertising services or voice recognition systems alone.

### SUMMARY OF THE INVENTION

The present invention provides a new and improved method for providing contextual applications that are based on the combination of voice recognition and location of a mobile device.

According to one aspect of the present invention, a method is provided that combines voice recognition with location information to create contextual advertisements, and a platform is presented that includes components that are necessary to enable such services. Thus, according to one aspect of the invention, a platform is provided that enables advertisers to create context-specific advertisements for end users.

According to another aspect of the invention, a method is presented for entering content to be transmitted into the system and delivered to the end user.

More specifically, a platform in accordance with the invention generally includes software and hardware components for sensing or otherwise determining the location of the user of the mobile device, i.e., the location of the mobile device, components for recording and potentially saving audio recordings of a user's voice, components for presenting the initiator (e.g., the user of the mobile device) with one or more interfaces to 1) record their voice and 2) potentially give permission to use location information to establish context, components for creating connections between the device or devices responsible for transmitting the content and one or more devices that are to receive the content, and network components which, via one or more communications networks, transmit communications or signals between a mobile device and a set of one or more receiving devices, and enable reception of content by the set of receiving mobile devices. With such structure, the invention provides a complete mobile platform and can be created to function on all active mobile device formats (regardless of operating system).

An advantage of the platform in accordance with the invention is the unique combination of voice recognition with the geographic location of the user to search for local services. The user is not required to manually type text into their mobile device to use the system.

Another advantage of the platform in accordance with the invention is that the user is not required to manually enter their location, though the user may have to give permission to the system before this information is available.

Yet another advantage of the platform in accordance with the invention relates to the manner in which advertisers are able to direct advertisements in a more meaningful way in comparison to previous advertising avenues. The system advantageously allows advertisers to create targeted advertisements based on a user's location and speech in the form of, for example, spoken queries.

### BRIEF DESCRIPTION OF THE DRAWINGS

The invention, together with further advantages thereof, may best be understood by reference to the following description taken in conjunction with the accompanying drawings, wherein like reference numerals identify like elements, and wherein:

FIG. 1 is a schematic showing the primary components of a mobile device that supports interaction and data transfer in accordance with the invention.

FIG. 2 is a schematic showing the process of data transfer between two or more mobile devices in accordance with the invention.

FIG. 3 provides an example interface that would allow an advertiser to create context-specific advertisements.

### DETAILED DESCRIPTION OF THE INVENTION

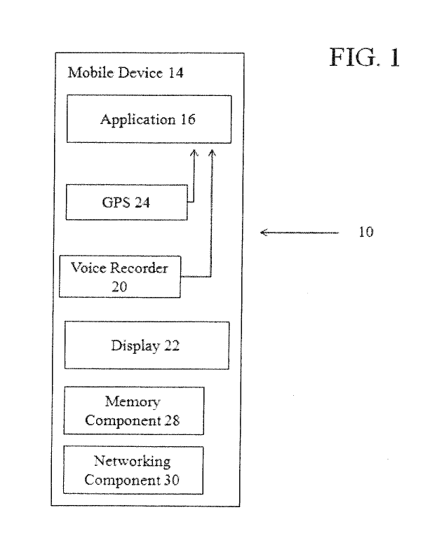

Referring to the accompanying drawings wherein like reference numerals refer to the same or similar elements, FIG. 1 shows primary components of a platform in accordance with the invention which is designated generally as 10. The primary components of the platform 10 are all shown resident on a mobile device 14. However, it is possible that one or more of the components is resident at a location apart from the mobile device 14 and communicates therewith to enable use of the platform 10.

Thus, mobile device 14 includes a display 22 which allows the user to view content, a memory component 28 for storing data (e.g. applications and data) and a networking component 30 for wireless communications. The networking component 30 is responsible for transmitting content between two or more networked systems. The transmission may occur via a set of signals, and may be transmitted using established networking protocols. The mobile device 14 also includes a location-determining system which is arranged to sense or otherwise determine the location of the mobile device 14. A common form of the location-determining system includes a GPS unit 24. Mobile device 14 also includes a system 20 for digitally recording voices, e.g., the user's voice.

The voice recording system 20 and the GPS unit 24 are coupled to a client application 16 so that the application 16 receives location information from GPS unit 24 as well as an audio recording from the voice recording system 20, Application 16 includes software embodied on computer-readable media which can interact with the voice recording system 20 and GPS unit 24 to cause them to provide this information.

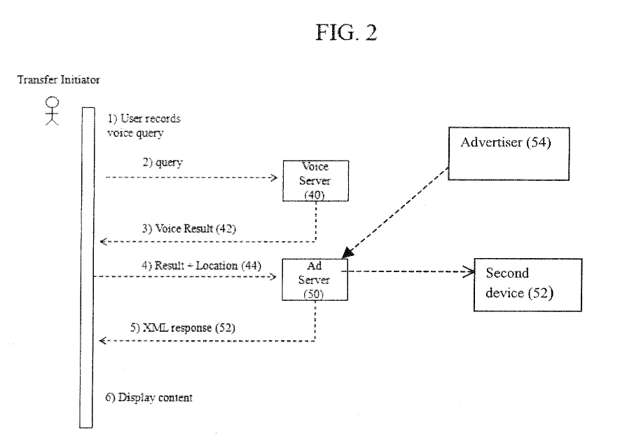

FIG. 2 shows an exemplifying process of transferring data between the mobile device 14 and a series of servers, The process begins with acquiring the user's voice via the voice recording system 20 and storing it temporarily into the memory component 28 of the mobile device 14. The form in which the recorded voice is stored may be in any known form. The stored recorded voice is then forwarded via networking component 30 to a server 40 which converts the spoken query into a set of one or more text strings. The client application 16 may include a program which determines whether a recoding of the user's voice is a query or not, and then only connects to the server 40 when the recorded voice is a query. The text string(s) is/are sent back to the mobile device 14, where they are combined with location data (or other contextual data, such as user preferences) derived from the GPS unit 24 and the combined text string(s) and location data is sent to an advertising server 50. The advertising server 50 returns one or more advertisements to the mobile device 14 based on both the query of the user (as reflected by the spoken query) as well as his location. Each advertisement provided by the advertisement server 50 may be in the form of an XML reply, wherein links to various and different forms of content may be obtained upon accessing or activating the links. For example, the advertisement server 50 may return a series of URL links including the company's main website, a URL of a video ad, and a link to an advertisement of a local sale. More generically, it may return a wide variety of multimedia content.

The advertisement server 50 may be arranged to deliver the response to the mobile device 14, the location of which was used to determine the response. Additionally or alternatively, the advertisement server 50 may be arranged to deliver the response to another device 52, mobile or otherwise, the identity of this device 52 and the manner in which the response is to be delivered being determined by, for example, the user of the mobile device 14.

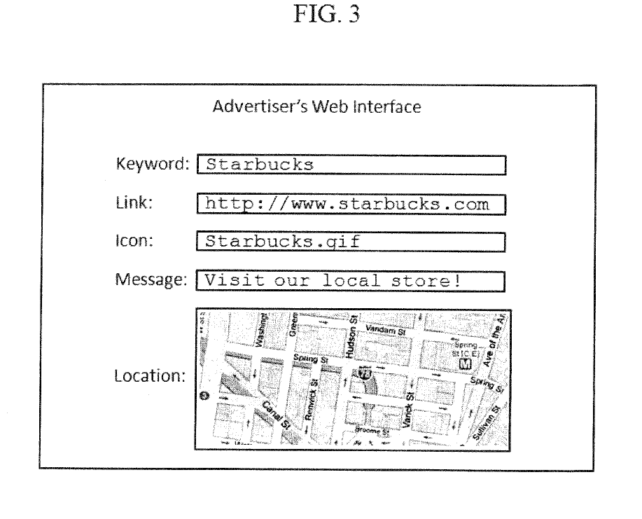

The process described in FIG. 2 is prefaced by the act of entering information by an advertiser into the advertisement server 50. FIG. 3 provides an exemplifying interface that would allow an advertiser to create a context-sensitive advertisement. The information to be entered by the advertiser includes a searchable keyword that identifies the advertiser, e.g., the company advertising its product or service. Additionally, it may include one or more multimedia components that are to be delivered upon recognition of this keyword, including icons, URL links, video, audio and/or a message. Ideally, the advertiser includes one or more geographic locations of the company. This content must be uploaded to the advertisement server 50 before it is delivered to the end user.

More generally, a system for enabling an advertiser 54 to target advertisements to a user of a mobile device 14, 52 in accordance with the invention includes the advertisement server 50 accessible by the advertiser 54 and which enables the advertiser 54 to provide one or more advertisements for delivery to the mobile device 14, 52, specify geographic advertising boundaries (location ranges), specify at least one keyword to trigger selection of an advertisement for delivery to the mobile device 14, 52 and specify the advertisement to be delivered in response to the specified keyword. When the advertisement server 50 receives a signal from the initiating mobile device 14 (or initiator) indicating its location and containing a keyword, it analyzes the keyword and the location of the mobile device 14 relative to the specified advertising boundaries for the advertiser 54 associated with that keyword, and determines an advertisement to be delivered based on the location of the mobile device 14 and the keyword. Different advertisers can be associated with different keywords and different advertisers can be associated with the same keywords but for different locations. Thus, the advertisement server 50 is preferably arranged to enable the advertiser 54 to associate different advertisements with different keywords and/or associate different advertisements with different locations.

In one embodiment when information about users of mobile devices 14 is provided, e.g. personal information such as age, sex, likes, dislikes, the advertisement server 50 may be arranged to enable the advertisers 54 to associate different advertisements based on information about the user of the mobile device 14. Thus, two users of mobile devices in the same location and speaking the same keyword could receive different advertisements if their information is different.

The application that resides on the mobile device 14 must contain a networking device (that accepts the protocol of the initiator, i.e., the advertisement server 50) that is capable of receiving content from the initiator. Further, it is assumed that the user who is receiving the content desires it; in another embodiment, the user of the mobile device 14 may be presented with a user interface to confirm that they wish to receive the content from the advertisement server 50.

The wireless transfer of data between any two devices or servers herein can occur across a wide variety of established networking protocols, such as wireless TCP/IP (or similar protocol). In a preferred embodiment, the transfer could occur across any available data connection.

In one embodiment, the advertisement server 50 may not be necessary to perform a search. For example, a user that launches the application 16 may speak the word “coffee” which is then sent to the voice server 40 for decoding. Upon receiving an equivalent text string 42 (i.e., “coffee”), it is packaged with the location of the user's mobile device 14 to construct a URL query against a third party mapping application (e.g., Google maps). The end result is the delivery of, for example, an XML reply to the mobile device 14 which causes display of a map on the display 22 of the mobile device 14 that pinpoints the user's location in relation to one or more local coffee shops.

In another embodiment, the spoken query is packaged with the location of the mobile device 14 into a unit 44 (without first providing the spoken query to the voice server 40) and sent to advertisement server 50 where a series of strings are returned, potentially in the form of an XML reply, which contain links to a variety of multimedia content. For example, by speaking the word “Starbucks” to be detected by their mobile device 14, a user may receive the Starbucks icon, their corporate website, a commercial, and a link to a coupon for the Starbucks that is closest to the user at the time the query was created, i.e., when the word “Starbucks” was spoken.

In view of the foregoing, the invention also contemplates a mobile device 14 capable of implementing these techniques which would include an application 16, the functions and capabilities of which are described above. The memory component 28 may include information about a user of the mobile device 14 which could be entered therein by a user interface of the mobile device 14. This information could also be used to determine the replies to be delivered to the user's mobile device 14 from the advertisement server 50, or replies to be presented to the user if multiple replies are provided by the advertisement server 50.

As noted above, a platform in accordance with the invention may include one or more of the above-described components which is resident at a location apart from the mobile device 14 and communicates therewith to enable use of the platform 10. Thus, the platform in accordance with the invention may be distributed over two or more mobile devices, or over one mobile device and another one or more non-mobile devices. For example, it is possible that while a first mobile device includes the voice recording system 20 and GPS unit 24 to enable generation and transmission of a signal derived from a spoken query and the location of the first mobile device via the networking component 30 thereof, the XML request generated by the advertisement server 50 in response to that signal transmission is directed to a second device other than the first mobile device, e.g., a second mobile device. This second mobile device would include a client application 16 and a networking component 30, among other components, with the client application being arranged to process the XML request received via the networking component 30 and display or otherwise provide the information to the user. The user of the first mobile device would be able to designate the second, receiving device or devices to which the responsive signal transmission is to be delivered from the advertisement server 50.

It is to be understood that the present invention is not limited to the embodiments described above, but include any and all embodiments within the scope of the following claims. While the invention has been described above with respect to specific apparatus and specific implementations, it should be clear that various modifications and alterations can be made, and various features of one embodiment can be included in other embodiments, within the scope of the present invention.

1. A platform for providing information to a mobile device, comprising:
a first mobile device arranged to capture spoken queries of a user, generate information which enables a location of the first mobile device to be determined, and transmit, in combination, a signal derived from the spoken query and the location of the first mobile device; and
a client application arranged to receive information derived from the signal transmitted by the first mobile device.

2. The platform of claim 1, wherein the client application is resident on the first mobile device.

3. The platform of claim 1, wherein the client application is resident on a second mobile device.

4. The platform of claim 3, wherein the first mobile device is arranged to at least one of receive identity information about the second device and deliver the information derived from the signal transmitted by the first mobile device to the second device.

5. The platform of claim 1, wherein the first mobile device includes a voice recording system to capture the spoken queries of the user.

6. The platform of claim 1, wherein the first mobile device includes a location determining system arranged to determine the location of the first mobile device.

7. The platform of claim 1, further comprising a voice server, wherein the first mobile device is arranged to transmit a captured spoken query to the voice server which converts the spoken query into at least one text string, wherein the voice server is arranged to transmit the at least one text string to the first mobile device, and wherein the first text string is the signal derived from the spoken query which is combined with the location of the first mobile device to create a context-specific query which is transmitted by the first mobile device.

8. The platform of claim 7, further comprising an advertisement server which receives the signal derived from a spoken query and the location of the first mobile device transmitted by the first mobile device and determines information to provide to the client application based thereon, and causes transmission of the determined information to the client application.

9. The platform of claim 8, wherein the determined information includes a variety of multimedia components.

10. The platform of claim 1, wherein the first mobile device is arranged to recognize an initiation of a search in the captured spoken queries.

11. The platform of claim 8, which the determined information includes context-specific media, including URLs or multimedia content.

12. A mobile device, comprising:
a transmitting unit for transmitting data packets;
a receiving unit for receiving content;
a voice recording system for recording speech; and
a location-determining system for determining a location of the mobile device,
wherein the transmitting unit is arranged to transmit, in combination, a signal derived from speech recorded by the voice recording system and the location of the mobile device as determined by the location-determining system, and
wherein the receiving unit is arranged to receive content based on the transmitted signal.

13. A system for enabling advertiser to target advertisements to a user of a mobile device, comprising:
an advertisement server accessible by the advertiser and which enables the advertiser to provide one or more advertisements for delivery to the mobile device, specify geographic advertising boundaries, specify at least one keyword to trigger selection of an advertisement for delivery to the mobile device and specify the advertisement to be delivered in response to the specified at least one keyword,
wherein said advertisement server is arranged to receive a signal from a mobile device indicating its location and containing the at least one keyword, analyze the location of the mobile device relative to the specified advertising boundaries, and determine an advertisement to be delivered based on the location of the mobile device and the at least one keyword.

14. The system of claim 13, wherein said advertisement server is arranged to enable the advertiser to associate different advertisements with different keywords.

15. The system of claim 13, wherein said advertisement server is arranged to enable the advertiser to associate different advertisements with different locations.

16. The system of claim 13, wherein said advertisement server is arranged to enable the advertiser to associate different advertisements based on information about the user of the mobile device.
